(19) United States
(12) Patent Application Publication
(10) Pub. No.: US 2014/0156752 A1
(43) Pub. Date: Jun. 5, 2014

(54) SOFTWARE APPLICATIONS FOR INTERACTING WITH LIVE EVENTS AND METHODS OF USE THEREOF AND CREATING CUSTOM CONTENT STREAMS

(71) Applicant: MICHAEL FETYKO, Costa Mesa, CA (US)

(72) Inventor: MICHAEL FETYKO, Costa Mesa, CA (US)

(73) Assignee: iConnectUS LLC, Costa Mesa, CA (US)

(21) Appl. No.: 13/893,286

(22) Filed: May 13, 2013

Related U.S. Application Data
(60) Provisional application No. 61/646,243, filed on May 11, 2012.

(51) Int. Cl. G06F 15/173

(52) U.S. Cl. CPC G06F 15/17306
USPC 709/204

(57) ABSTRACT

A computer-implemented method of providing an interactive experience to an attendee at a live event, the method comprising: displaying, via a display on a mobile device, a plurality of interaction elements, wherein a first subset of the interaction elements is designed for use prior to a live event, a second subset of the interaction elements is designed for use during the live event and a third subset of the interaction elements is designed for use after the live event.

### CROSS-REFERENCE TO RELATED APPLICATION

This application claims the benefit of U.S. Provisional Application No. 61/646,243 filed May 11, 2012.

### FIELD

The present patent document relates to applications for interaction with live events and their methods of use. In particular, the present patent document relates to an application for a mobile device, television, or other display platform designed to complement and enhance a fans experience at or with a live event.

### BACKGROUND

People attend and watch live sporting events, concerts, plays and various types of other activities and social gatherings. The experience that one has at such an event may be enriched by other people at the same event or by social interaction with the event.

### SUMMARY

In view of the foregoing, one aspect of the various disclosed embodiments in the present patent document is to provide improved methods and apparatuses for enhancing the experience of a consumer of a live event. Preferably the methods and apparatuses address, or at least ameliorate, one or more of the problems described above. To this end, a computer-implemented method of providing an interactive experience to an attendee at a live event is provided. In one embodiment, the method comprises displaying, via a display on a mobile device, a plurality of interaction elements, wherein a first subset of the interaction elements is designed for use prior to a live event, a second subset of the interaction elements is designed for use during the live event and a third subset of the interaction elements is designed for use after the live event.

Some embodiments of the computer implemented method may further comprise the step of awarding credits or points to an attendee based on a level of participation with the interaction elements. In some embodiments where points or credits are awarded, those points or credits may be awarded to the attendee for uploading content or information about the live event to a social media outlet. In some embodiments, the social media outlet may be Facebook®.

In a preferred embodiment, the computer implemented method includes a plurality of interaction elements. In some embodiments, one of the interaction elements of the first subset is designed to allow the attendee to submit a question to a participant of the live event. In some of the embodiments that allow a user to submit a question, the question is submitted in video form.

In yet another embodiment of the computer implemented method, one of the interaction elements of the second subset is designed to allow the user to rate the attractiveness of other attendees of the live event.

In yet another embodiment of the computer implemented method, one of the interaction elements of the third subset is designed to allow the user to redeem points or credits for rewards. In some of those embodiments, the rewards are selected from the group consisting of coupons, merchandise, concessions or memorabilia.

Some of the embodiments disclosed herein are embodied in a non-transitory computer-readable medium having computer-readable instructions stored thereon wherein the computer-readable instructions are designed to facilitate interaction with an attendee of a live event. In one of those embodiments, the computer-readable instructions comprise a first state, designed to interact with an attendee prior to the live event; a second state, designed to interact with an attendee during the live event; and a third state, designed to interact with an attendee after the live event.

In some embodiments of the non-transitory computer-readable medium, the computer readable instructions further comprise a point or credit allocation system. In some of those embodiments, the point or credit allocation system allocates points or credits based on the attendees' level of interaction with the computer readable instructions. In some of the embodiments, the points or credits are redeemed for a prize selected from the group consisting of coupons, merchandise and memorabilia. In yet other embodiments, the credits are redeem by wagering them against other attendees at the live event.

The preferred embodiments of the live event application are designed for use with a mobile device such as a mobile phone or tablet.

### BRIEF DESCRIPTION OF THE DRAWINGS

FIG. 1 illustrates one embodiment of a dashboard interaction grid type user interface.

FIG. 2 illustrates an expanded view of one embodiment of an “Ask the Expert” or “Questions” interaction element.

FIG. 3 illustrates one embodiment of a splash screen that may be provided to a user after submitting a question.

FIG. 4A illustrates one embodiment of a screen designed to allow a user to customize their video question before submitting to Facebook.

FIG. 4B illustrates one embodiment of a splash screen that may be provided by the application informing the user of additional points or credits they have acquired for uploading their question to a social media outlet.

FIG. 5 illustrates an expanded view of one embodiment of a friends interaction element.

FIG. 6 illustrates an expanded view of one embodiment of an info/buzz interaction element.

FIG. 7 illustrates an expanded view of one embodiment of an iReport interaction element.

FIG. 8 illustrates an expanded view of a screen for playing a “Spot A Hottie” game.

FIG. 9 illustrates an expanded view one embodiment of a leaderboard interaction element.

FIG. 10 illustrates an expanded view one embodiment of a rewards interaction element.

### DETAILED DESCRIPTION OF THE EMBODIMENTS

The following detailed description includes representative examples utilizing numerous features and teachings, both separately and in combination, and describes numerous embodiments in further detail with reference to the attached documents. This detailed description is merely intended to teach a person of skill in the art further details for practicing preferred aspects of the present teachings and is not intended to limit the scope of the claims. Therefore, combinations of features disclosed in the following detailed description and incorporated documents may not be necessary to practice the teachings in the broadest sense, and are instead taught merely to describe particularly representative examples of the present teachings.

Some portions of the detailed descriptions that follow in the incorporated documents are presented in terms of algorithms and sequences of operations which are performed within a computer memory. These algorithmic descriptions and representations are the means used by those skilled in the data processing arts to most effectively convey the substance of their work to others skilled in the art. An algorithm or sequence of operations is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic device, that manipulates and transforms data represented as physical (electronic) quantities within the computer system's registers and memories into other data similarly represented as physical quantities within the electronic device's memory or registers or other such information storage, transmission or display devices.

The embodiments disclosed also relate to an apparatus for performing the operations herein. This apparatus may be specially constructed for the required purposes, or it may comprise a general purpose processor selectively activated or reconfigured by a computer program stored in the electronic device. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, Flash memory, magnetic or optical cards, or any type of media suitable for storing electronic instructions, and each coupled to a computer system bus.

The algorithms presented herein are not inherently related to any particular electronic device or other apparatus. Various general purpose systems may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the embodiments as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

For the purposes of this disclosure, the term “content” or “media” is used broadly to encompass any product type or category of creative work including any work that is in an electronic form that is renderable, experienceable, retrievable, computer-readable filed and/or stored in memory, either singly or collectively. Individual items of content or media include songs, tracks, pictures, images, movies, articles, books, ratings, reviews, descriptive tags, or computer-readable files, however, the use of any one term is not to be considered limiting as the concepts features and functions described herein are generally intended to apply to any work that may be experienced by a user, whether aurally, visually or otherwise, in any manner now known or to become known. Further, the term content or media includes audio, video, pictures and products embodying the same. As mentioned above, while there are many digital forms and standards for audio, video, digital or analog media data and content, embodiments of the systems and methods described herein may be equally adapted to any format or standard now known or to become known.

For purposes of this disclosure, the term “social network” refers to an online community in which community members can interact or transfer information and can include chat rooms, email accounts, forums, instant messaging, media/photo management and sharing. Further, the term “social network” refers to a web-based system for facilitating applications such as e-mail application, calendar application, chat room application, instant messaging application, and media/photo management and sharing application.

In one embodiment, the system may be implemented in one or more functional modules. As used herein, the term module refers to logic embodied in hardware or firmware, or to a collection of software instructions, possibly having entry and exit points, written in a programming language, such as, for example, C++. A software module may be compiled and linked into an executable program, or installed in a dynamic link library, or may be written in an interpretive language such as BASIC. It will be appreciated that software modules may be callable from other modules, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays. The modules described herein are preferably implemented as software modules, but could be represented in hardware or firmware.

In one embodiment, each module is provided as a modular code object, where the code objects typically interact through a set of standardized function calls. In one embodiment, the code objects are written in a suitable software language such as C++, but the code objects can be written in any low level or high level language. In one embodiment, the code modules are implemented in C++ and compiled on a computer running a content server, such as, for example, Microsoft™ IIS or Linux™ Apache. Alternatively, the code modules can be compiled with their own front end on a kiosk, or can be compiled on a cluster of server machines serving interactive television content through a cable, packet, telephone, satellite, or other telecommunications network. Artisans of skill in the art will recognize that any number of implementations, including code implementations directly to hardware, are also possible.

For example, the system may include a database. As is well known, database categories above can be combined, further divided or cross-correlated, and any combination of databases and the like can be provided from within a server. In one embodiment, any portion of the databases can be provided externally from the website, either locally on the server, or remotely over a network. The external data from an external database can be provided in any standardized form which the server can understand. For example, an external database at a provider can advantageously provide end-user data in response to requests from server in a standard format, such as, for example, name, user identification, and computer identification number, and the like, and the end-user data blocks are transformed by a database management module into a function call format which the code modules can understand. The database management module may be a standard SQL server, where dynamic requests from the server build forms from the various databases used by the website as well as store and retrieve related data on the various databases.

As can be appreciated, the databases may be used to store, arrange and retrieve data. The databases may be storage devices such as machine-readable mediums, which may be any mechanism that provides (i.e. stores and/or transmits) information in a form readable by a processor. For example, the machine-readable medium may be a read only memory (ROM), a random access memory (RAM), a cache, a hard disk drive, a floppy disk drive, a magnetic disk storage media, an optical storage media, a flash memory device or any other device capable of storing information. Additionally, machine-readable medium may also comprise computer storage media and communication media. Machine-readable medium includes volatile and non-volatile, removable and non-removable media implemented in any method or technology for storage of information such as computer-readable instructions, data structures, program modules or other data. Machine-readable medium also includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by a computer.

According to a feature of the present disclosure, a machine-readable medium is disclosed. The machine-readable medium provides instructions, which when read by a processor, cause the machine to perform operations described or illustrated herein. The machine-readable medium may be any mechanism that provides (i.e. stores and/or transmits) information in a form readable by the processor. For example, the machine-readable medium may be a read only memory (ROM), a random access memory (RAM), a cache, a hard disk drive, a floppy disk drive, a magnetic disk storage media, an optical storage media, a flash memory device or any other device capable of storing information.

As used herein, the term “social media outlets” includes Facebook, Twitter, Myspace, FourSquare, Pintrest, YouTube, or any other type of social media outlet. As used herein, “social media channels” includes any method of interacting with other people via a social media outlet, including but not limited to text, private message, email, posting to their home page, tweeting, status updates, likes, sharing or any other type of interacting.

The present patent document describes unique systems and methods for applications and other computer based software applications to interact with live events. Embodiments of the present patent document provide a simple yet very powerful way for people to participate in live events. The applications may be immersive such that users can learn about the live event details from game analysts, stars, athletes, social influencers or any other person involved with the live event. In a preferred embodiment, a software application is provided that is a social game application that is designed to complement and enhance the live event experience with engaging features and information. In a preferred embodiment, the applications provide entertainment destinations that transform fans into social influence marketers.

The display platform for interaction with the live event may be any electronic device including a computer, laptop, mobile phone, mobile tablet, personal data assistant (PDA) or any other type of electronic device. Furthermore, the display platform may be either a mobile device or may be a wired television computer or other stationary system. In a preferred embodiment, the display platform is a mobile device. In an even more preferable embodiment, the display platform is a smart-phone such as the iPhone®, Blackberry®, Droid®, One®, Galaxy®, or any other smart-phones.

In a preferred embodiment, a software application or plurality of software applications are provided. In such embodiments, the applications may be developed for the iOS operating system, the Android operating system, the windows mobile operating system, or the operating system of any other mobile device. In other embodiments, the software application or plurality of applications may be developed as a Facebook® Game or Web Portal. In other embodiments, the software application may be designed for other platforms.

There are various types of people that may wish to interact with the live event software application. Accordingly, the live event software application may have different user levels with different permissions and log-ins. In a preferred embodiment, the software application has at least four types of users: 1) Event Administrator; 2) Sponsor; 3) User of the end application; and 4) Administrator from the software provider. When referring to a “user” within this patent document, the application is generally referring to a user of the end application.

In a preferred embodiment, users may be given an incentive to use the application. In one embodiment, the users may be given points or credits for participating or performing certain acts within the application. In some embodiments, the points or credits earned by the users may then be redeemed for rewards. Rewards may include discounts to the event tickets, preferred parking, preferred seating, coupons, merchandise, prizes or any other type of incentive. In some embodiments, the points or credits may be wagered on the event's outcome. Such wagering may result in more points or any other type of reward. In some embodiments, the total points obtained by a user may be tracked and used to affect the users experience with the application. For example, a user with a higher number of total points may have access to a larger feature set of the application than users with fewer total points.

In some embodiments, a leader board may be provided such that users may track their points with respect to other users. Other awards, such as virtual ribbons or badges may also be awarded. In different embodiments, points or credits may be awarded in various different ways. In a preferred embodiment, points or credits may be awarded based on an award prompt or points may be simply added to the user total without prompting.

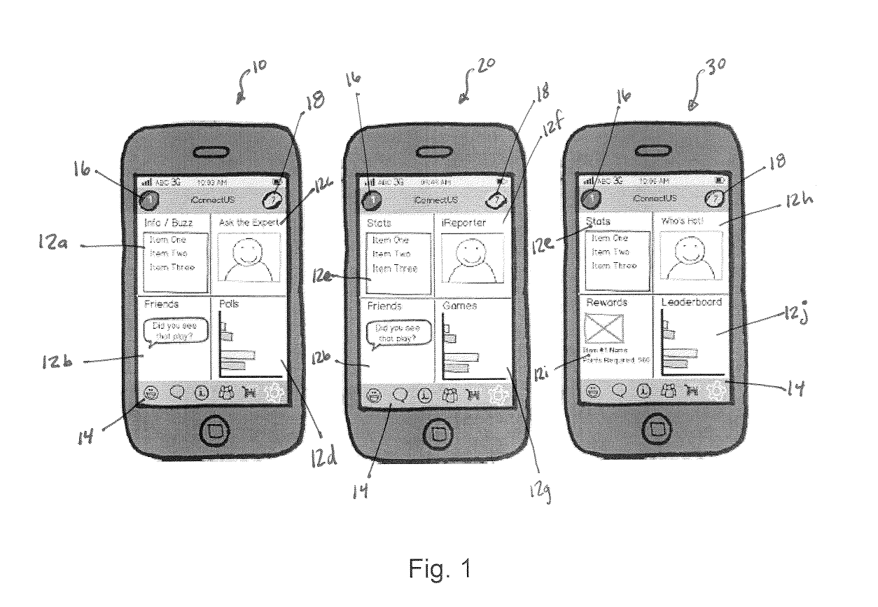

In various different embodiments, different types of user interfaces may be used. FIG. 1 illustrates one embodiment of a dashboard interaction grid type user interface 10, 20 and 30. As may be seen in FIG. 1, each box of the grid may contain a different interaction element 12a-12j. An interaction element, is any element, within the larger program, designed to allow the user to send or receive data related to the event or communicate with other users or people associated with the live event. When a user selects any one of the grid boxes, that box may zoom or expand to fill the display. In other embodiments, or within the same embodiment, other types of user interfaces may be used such as vertical scroll, horizontal slid or wipe and home button return.

In addition to the interaction grid, in some embodiments, the interface may contain a tool bar or plurality of tool bars 14. The tool bars may contain icons that link the user to various different other interaction elements 12a-12j or to outside links such as email, social media outlets, chat or any other type of desirable link or Universal Resource Locator URL. In addition to the toolbar, the interface may have any number of other icons or indicators. As just one example, the interface may contain a number of indicators 16 and 18 for pending messages for a user, number of points or credits the user has earned, or other indicators. The indicators may also be links to outside or in application resources that allow the user to process the information related to the indicator.

In a preferred embodiment, the live event application includes 3 primary states of operation: 1) pre-event; 2) live event; and 3) post event. In other embodiments, other states are possible. In yet other embodiments, fewer states may be possible. Depending on the state of the application, different interaction element 12a-12j may be displayed. Certain interaction elements may be displayed in multiple states.

Regardless of the state of operation of the application, or the particular interaction element that may be engaged, advertising may be provided. Advertising may be in the form of static or dynamic ads, pops ups, banners, toolbars or any other method of digital advertising. Advertising may be sophisticated and target individual users based on their preferences or may be directed to all the users.

In the preferred embodiment, the interaction elements 12a-12j associated with the pre-event state may generally be divided into three categories: 1) content creation; 2) advertising; and 3) Social media interaction. In other embodiments, the pre-event state may perform other functions or omit some of the listed functions. In a preferred embodiment, pre-event actions are designed to allow the users and attendees of the live event to help increase awareness of the event or the “buzz” around the event. This may help advertise the event. Other objectives of the pre-event state include enrolling attendees in software application games, promoting live game participation, and fostering grass-roots referrals through friend recruitment.

Content creation may be any type of content creation. In some embodiments, the content may be created by users. In other embodiments, the content may be created by the application. In a preferred embodiment, the content is created by the users with assistance and/or prompting from the application.

One example of content creation may include questions from users. Questions may be submitted, in the form of video, audio, text or any other form. Interaction element 12c “Ask the Expert” is one example of an interaction element that allows the user to ask a question. Although the embodiment in FIG. 1 has an interaction element titled “Ask the Expert,” in other embodiments, questions may be directed to any person associated with the event. For example, the questions may be directed to stars, athletes, celebrities, experts, announcers, cheerleaders or any other person associated with the event. Responses may also be in any form including video, audio, text or any other suitable form.

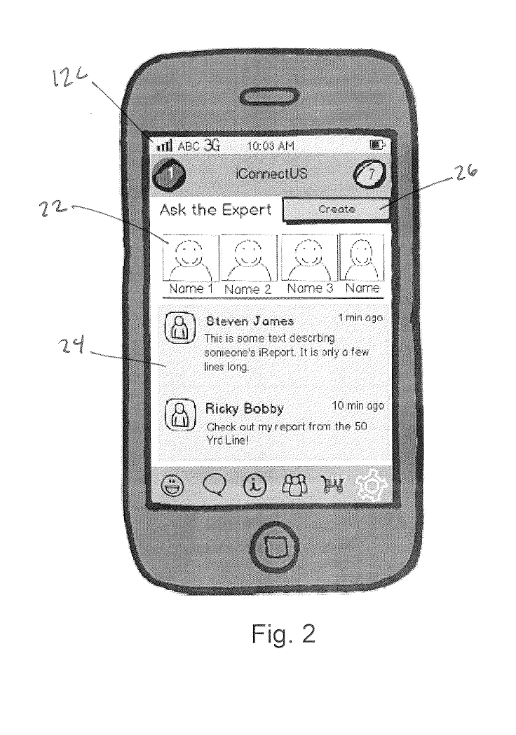

FIG. 2 illustrates an expanded view of one embodiment of an “Ask the Expert” or “Questions” interaction element 12c. The interaction element 12c shown in FIG. 2 includes a create question button 26, a list of available individuals to ask a question to 22, and a list of recent questions 24. In other embodiments, other configurations or components are possible.

In operation, the user may select an individual to ask a question to from the list of available individuals 22. The user is then prompted to enter their question. When the question is a video question, the user will be prompted to record a video question. Once the video is recorded, the user may be provided a chance to review the video question and then decide whether to submit it or record the question again.

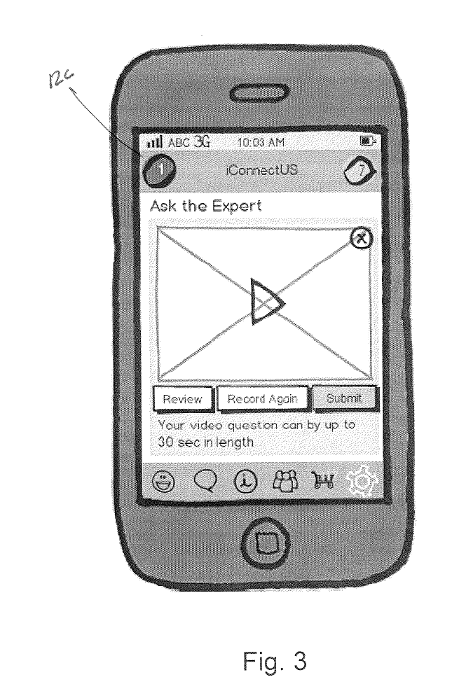

In some embodiments, if the user chooses to submit the video, the user may be awarded points or credits. FIG. 3 illustrates one embodiment of a splash screen that may be provided to a user after submitting a question. In addition to alerting the user of the points or credits they have acquired, the splash screen might further prompt the user to submit the question to a social media outlet and/or invite a friend to an event.

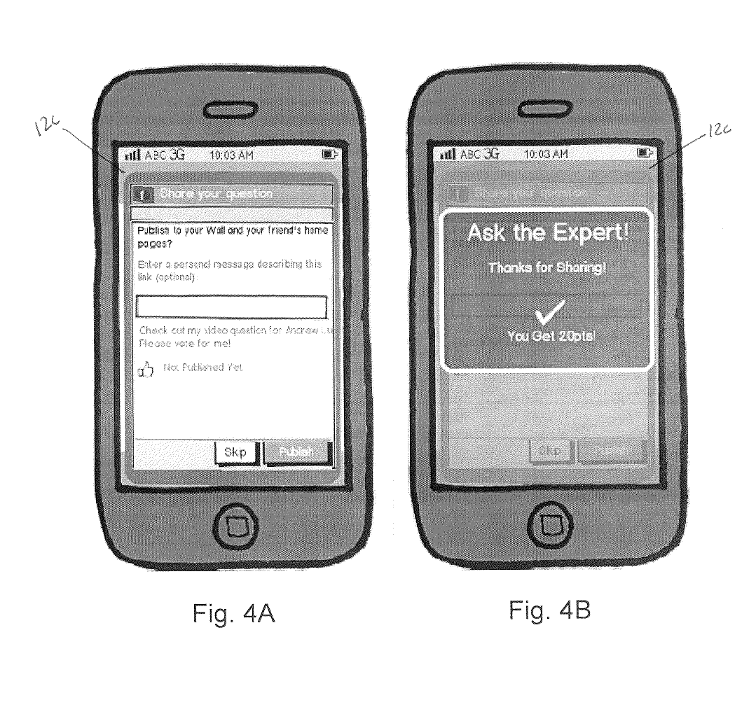

If the user chooses to submit the question to a social media outlet, the user might obtain an additional screen that allows the user to customize the question for the particular social media outlet. FIG. 4A illustrates one embodiment of a screen designed to allow a user to customize their video question before submitting the video question to Facebook. As may be seen in FIG. 4A, the user may be prompted to enter a personalized message about their questions before submitting it to the social media outlet. In other embodiments, other methods of customizing the question may be provided prior to submitting it to the social media outlet. FIG. 4B illustrates one embodiment of a splash screen that may be provided by the application informing the user of additional points or credits they have acquired for uploading their question to a social media outlet.

Generally speaking, any of the interaction elements may enable the user to share event details on social media channels and receive points or credits for doing so. In embodiments that allow users access to their social media channels through the application, the application may include buttons to allow the users to Facebook® like the live event, share the event, Twitter® tweet about the live event, or Twitter follow the live event, star, athlete or other persons associated with the live event.

In a preferred embodiment, the application may manage the questions and responses and create a playlist to broadcast. The broadcast may occur before the event, during the event, or after the event. In a preferred embodiment, the playlist may be saved on a server and be available at any time after it has been created such that a user may view the broadcast at his or her leisure.

In some embodiments, the application may also supply advertising to the users. Advertising may be pop up ads, banner ads, videos or any other type of media based advertising that may be viewed on the platform. In yet other embodiments, other forms of media advertising may be used.

Returning to FIG. 1, in some embodiments, an interaction element 12b may be provided that allows users to contact their friends. Friends may be friends from the event or friends from other social media outlets. The interaction element 12b may be available in the pre-event, live event or post even state.

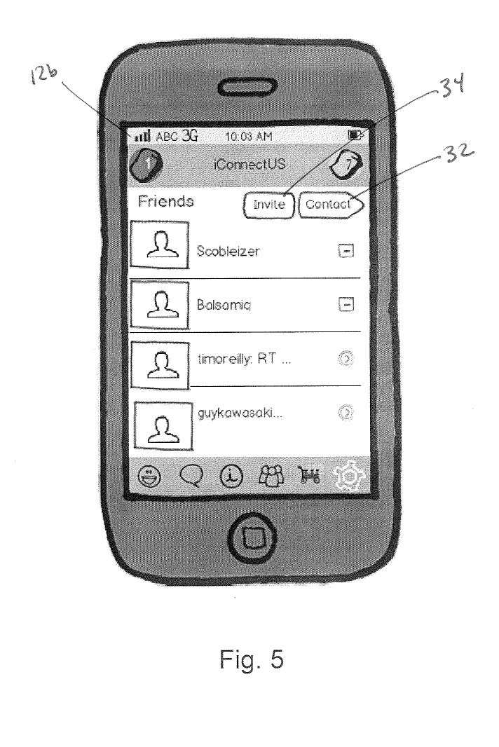

FIG. 5 illustrates an expanded view of one embodiment of a friends interaction element 12b. In a preferred embodiment, the interaction element 12b includes a scrollable list of friends, an invite button 34 and a contact button 32. The interaction element 12b may allow the user to invite friends to attend the live event by selecting the invite button 34. Users may also contact friends and send them a message about the live event. The scrollable list of friends may be populated from social media outlets and then augmented with additional friends the user adds through the software application.

In a preferred embodiment, the interaction element 12b allows attendees or users of the application to chat with other attendees of the live event or users of the application. The chat may be facilitated through a private chat program within the application or simply connect users through an already established chat channel provided by a social media outlet or any other chat facility. In this way, users may be able to chat with “friends” from a social media outlet or chat with other people they do not know but who are attending the event. Chat's may be global or may be private i.e., between only a couple or few individuals.

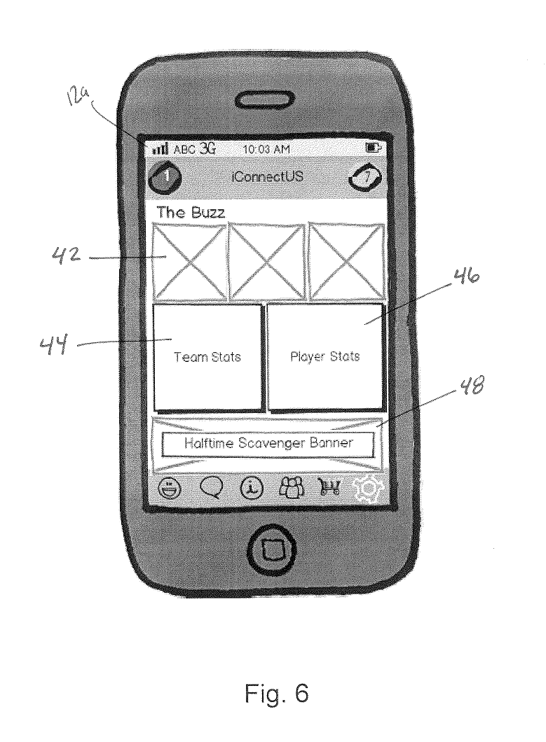

Returning to FIG. 1, in a preferred embodiment, an info/buzz interaction element 12a may be provided. FIG. 6 illustrates an expanded view of one embodiment of an info/buzz interaction element 12a. The info/buzz interaction element may provide featured news items 42, team or event specific news 44 and player or artist specific news or stats 46. In embodiments where a star, athlete or other famous person will be performing at the live event, the info/buzz interaction element 12a may provide users of the application with information about the star, athlete or other famous person. Interaction element 12a is one example of an interaction element designed to provide information to the user. The information may include pictures or stats and may be exclusive to the users of the application. This information may come in the form of a “star splash page.”

In some embodiments, the interaction element 12a may provide users with other information about the event such as directions to the venue, seating charts, a countdown to the event; the number of other attendees; weather predictions, parking information or any other type of useful information about the upcoming live event. The information interaction element 12a may be available in all three states of the application.

In some embodiments of the info/buzz interaction element 12a, additional items may be provided to help further create buzz about the live event. In the example shown in FIG. 6, a halftime scavenger hunt banner 48 is provided. In other embodiments, other promotional items or advertising may be used. In the embodiment shown in FIG. 6, if the user selects the halftime scavenger hunt banner 48, the user may be supplied more information about the scavenger hunt, the items that need to by located, the points or credits for finding certain items, or the rewards offered for cashing in points or credits. For example, the user might be presented information that 500 points will be enough to obtain free Coke, or a team tee-shirt may be obtained for 1700 points.

Returning to FIG. 1, in some embodiments, the live event software application may include a polling interaction element 12d. The polling interaction element 12d may allow users to start and participate in polls about the live event. For example, if the live event is a sporting event, the polling interaction element 12d may allow the user to select a winner of the game. In other embodiments, the polls may be started by the event admin or other administrator. In a preferred embodiment, the polling interaction element 12d also provides the users with the latest results of the various polls that are running. In embodiments that provide results, the results may only be shown if the user has answered the poll. In a preferred embodiment, the user will be limited to answering each poll only once.

In some embodiments, the polling interaction element may be supplied by the live event application. In other embodiments, the poll may be imported from another social media outlet and exist as bubble overlay within the live event application.

The preferred embodiments of the application all have a state that runs during the live event. In a preferred embodiment, the user must be physically at the event in order to use the live event state of the application. Verifying the user is at the live event may be done in a number of ways including GPS, Google Maps check in, FourSquare check in, Facebook Check in or any number of other positional related applications. In a preferred embodiment, users may receive points or credits for checking in at the live event.

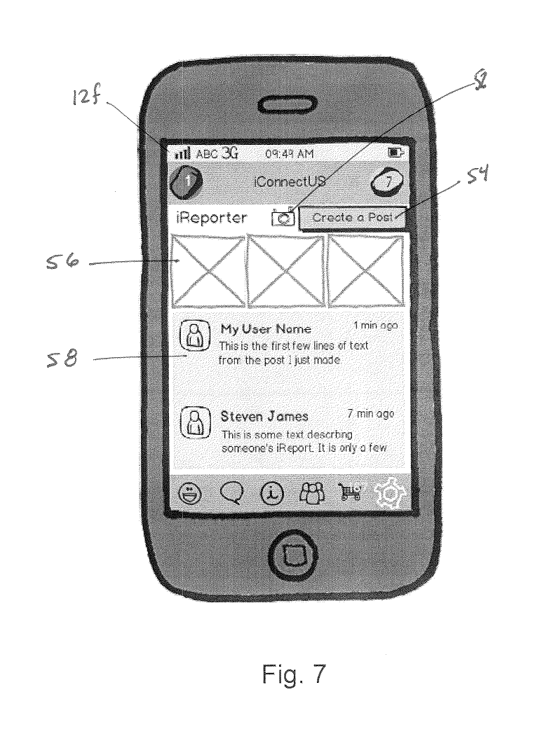

As mentioned above, the live video questions and responses submitted during the pre-event state may be viewable during the live event. In a preferred embodiment, users of the application may receive various types of content including, star videos, vj videos, UGC videos or any other type of videos. In addition to the videos already available, a user participating in the live event state of the application may use the iReport interaction element 12f to create a report about the game. FIG. 7 illustrates an expanded view of an iReport interaction element 12f.

An iReporter interaction element 12f may allow a user to create an iReport of the live event. The iReport may include video, pictures, audio, text or any other type of media. The iReporter interaction element 12f may allow users to create and edit the iReport and post it to their social media outlets or send it to other people via email, SMS or any other type of communication.

As may be seen in FIG. 7, and iReport interaction element 12f may include a camera button 52, a create a post button 54, a featured item scroller 56 and a feed of past iReports 58. The camera button 52 allows the user to take a picture or video with the smart phone camera. The photo or video may be submitted as the entire iReport without more. In some embodiments, the camera button may be restricted to taking a new picture or video to help ensure the picture or video is from the live event.

In a preferred embodiment, selecting on the create a post button 54 allows the user to create a more detailed iReport. Once the create a post button 54 is selected, the user may be taken to a new screen and allowed to create their report. In a preferred embodiment, the user may submit a free form text based post as part of their iReport. The post may also include photos, videos, audio or any other type of digital media. Whenever the user submits an iReport, the user may be awarded points or credits as an incentive for submitting the report.

As may be seen in FIG. 7, in some embodiments of the iReport interaction element 12f, a featured item scroller 56 may be provided. The featured item scroller 56 may include iReports that may be most beneficial to a user. The ranking of how an iReport becomes a featured item might be based on popularity of the iReport with other users or may be assigned by an administrator. The featured item scroller 56 may include other items such as advertisements or promotions mixed in with iReports.

In a preferred embodiment of the iReport interaction element 12f, the user may also be shown a feed of the latest iReports 58 that have been submitted. In a preferred embodiment, the feed of the latest iReports 58 should allow the user to scroll through the reports. The embodiment shown in FIG. 7 allows the user to vertically scroll through the feed of the latest iReports 58.

Entries in the scrollable list of the latest iReports 58 may include summary information about the iReport so that a user can make a preliminary determination about whether they want to consume the full iReport. Preliminary information may include a user icon which may be a picture of the user that submitted the report. In other embodiments an avatar may be used instead of a picture of the user. The preliminary information may also include the user's name, which may be an actual name or screen name. The preliminary information may also include the post time and a subset of the post. If a user selects on the preliminary information of an entry in the feed of the latest iReports 58, the user may be taken to an expanded screen with the full information of the iReport. Whenever a new iReport is submitted, it may be placed at the top of the feed of the latest iReports 58.

The iReport interaction element 12f may give users various opportunities to interface with their social media outlets. For example, the users may be requested or given the opportunity to post their iReport to a social media outlet. In addition, the user may “like” or “share” someone else's iReport to a social media outlet. In a preferred embodiment, points or credits may be awarded to the user for “liking” or “sharing” an iReport to a social media outlet or posting their own iReport to a social media outlet.

Returning to FIG. 1, in a preferred embodiment, an interaction element 12g may be provided to allow the users to play games. The games interaction element 12g may include games related to the live event. When a user selects on the games interaction element 12g, the user may be provided with a screen that lists a number of games the user can select from. The number of games available may be limited by the number of games enabled by the administrators. For different events, different games may be enabled.

Many different kinds of games may be provided by the interactive game element 12g. For example, games may include the ability to wager on the live event. For example, if the live event is a sporting event, the games interaction element 12g may allow users to wager, money, points, credits or some other value item with other users. The value item may have real value or only virtual value.

Other types of games may also be provided such as a trivia game, a scavenger hunt or any other type of game. Trivia games may be specifically targeted to the live event such that the questions reflect knowledge of the teams, bands, players or stars participating in the live event. Credits or points may be awarded for successfully answering trivia questions. In some embodiments, participants in the trivia game may battle other attendees at the event to try and answer the questions as quickly as possible to obtain the points or credits.

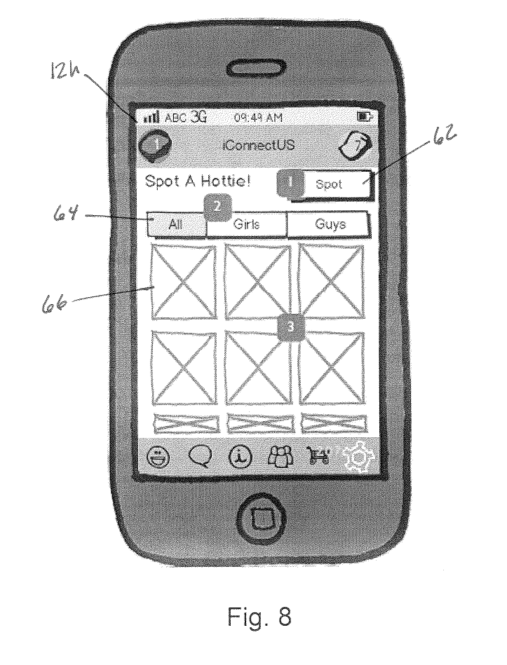

FIG. 8 illustrates an expanded view of a screen for playing a “Spot A Hottie” game 12h. Interaction element 12h may also be referred to as a “Who's Hot” game. The “Who's Hot” interaction element 12h may be a subset of the games interaction element 12g or may be its own interaction element. As may be seen in FIG. 8, the “Spot a Hottie” screen may include a spot button 62, a filtering interface 64, and the results 66.

The “Spot A Hottie” game allows users at a live event to take a photograph of another person at the live event and post the image to the game. Users may then vote on whether they think the person is “hot” or “not hot.” The term “hot” being used here to refer to the attractiveness of the person. In a preferred embodiment, the results may be filtered to protect people's feelings such that only the positive results are shown. In other embodiments, users may only be able to submit a positive result by selecting on a person and voting for them as hot but not given the option to vote people as being “not hot.”

The results portion of the “Who's Hot” interaction element 12h may filter the results by time, such that the latest posts are shown. The results may also be filtered by results, such that the pictures with the most “hot” votes are shown first or last. In other embodiments, the user may be able to select how to filter the results. To this end, a filtering interface 64 may be provided. The filtering interface 64 shown in FIG. 8 only includes the ability to filter by gender. In other embodiments, more advanced filters are possible including by rank and time as suggested above.

In a preferred embodiment, when a user selects on one of the images in the results page of the “Who's Hot” interaction element 12h, a larger image may be provided. Along with the larger image, rating interface may be provided. The rating interface may simply allow the user to choose between “hot” or “not hot” or may be a more sophisticated ranking. For example, the user may be able to rate the person on a scale of 1 to 10. Each image would then have a cumulative score based on all the ratings or may have a total of all the “hot” or “not hot” selections. In some embodiments, both types of ratings may be possible. In a preferred embodiment, a user may only rate an image a single time. After rating the image they can still view the image and get an updated rating but they cannot rate or rank the image again.

In addition to the image and the current ranking information of each entry in the “Who's Hot” game, other information such as location of the person at the live event may be added. For example, below the image might appear some text based information like “blonde girl in row 37B” or something similar. When a user votes on an image, a few points or credits may be awarded. In a preferred embodiment, the award of credits or points may be performed without notifying the user. In other embodiments, a splash screen may be provided to notify the user of the points or credits.

The “Spot A Hottie” interaction element may include an interface to allow users to upload a candidate for evaluation. In the embodiment shown in FIG. 8, a “Spot” button 62 is provided as the interface. When the user selects the “Spot” button 62, the user is directed to the camera utility of the platform the live event application is running on. The user may then snap a picture of the candidate they would like to submit for evaluation. In a preferred embodiment, the user may be restricted to an in application camera utility to restrict users to taking new pictures at the live event. The idea is to limit submissions by users to people that are actually at the live event. Once a picture of video is obtained, the user may be able to provide additional information to be associated with the video or picture. This additional information may simply be a note from the user, information about the location of the candidate in the venue, the gender of the candidate, or any other type of information. In some embodiments, no additional information may be added to the picture or video. The user may post the candidates picture to the “Spot A Hottie” application and other users may then be notified of the new candidate and participate in ranking the candidate. In some embodiments, the user may be awarded points or credits for nominating a candidate to the “Spot a Hottie” interaction element.

Another feature of the live event state of some of the embodiments is the ability to post comments about the event that other users or attendees of the live event may see. These messages may be broadcast to the platforms of all the users/attendees; may be broadcast to the platforms of a subset of users/attendees; or may be sent to the platform of an individual user/attendee. In some embodiments, the messages may be sent to a media platform owned by the live event venue such as a jumbotron or other large screen. In this way, users/attendees can send messages that may be seen by the entire crowd or attendees of the live event.

Returning to FIG. 1, the live event state of some embodiments may also include an interaction element 12e to provide statistics about the live event. For example, if the live event is a sports event, the stats may include both current stats about the players or teams, or historical information about the players or teams. The stats may be any relevant information about the live event or participants in the live event and may be current or historical. As another example, if the live event is a concert, information about the band or performer may be provided.

The preferred embodiments of the application also have a state that runs after the live event is over or a post event state. In some embodiments, the users may receive a splash screen that notifies them that the event has ended. The splash screen may give them a limited amount of time to continue to use the live event state of the application and obtain points or credits. Once the live event state expires, the users may be restricted to the post event state of the application.

In some embodiments, users of the live event application may view archived footage of the live event on demand in the post event state of the application. In addition, the users of the application may be able to view any of the archived information created during the pre-event or live event. As just one example, the users of the application may be able to view the questions and responses submitted prior to and/or during the event.

In a preferred embodiment, the users may be able to continue to post comments about the event after the event has ended. If the event repeats itself, such as concerts that play at different venues around the country, the post event comments may be archived and available to other users of the application at an upcoming live event at a different venue. Similar to the other states of the application, users may be able to share information through social media in the post event state of the application as well.

In one embodiment, the highest ranked candidates from the “Who's Hot” interaction element may be available for viewing after the event. The highest ranked candidate may receive a reward of some kind for participating. The reward may be points, credits, money or merchandise to name a few. In another embodiment, the highest ranked candidates from the “Who's Hot” interaction element may become finalists and further voting is conducted during the post event state to select the final winners. For example, the top 10 candidates may be available for viewing and users are able to rank the top 3.

In a preferred embodiment, the stats interaction element 12e may provide a game summary with all the stats about the game, teams and players. In some embodiments, the stats may be linked to videos and highlights from the game. In some embodiments, the stats interaction element 12e may also provide stats about the number of users of the application or other interesting information about the participants in the application.

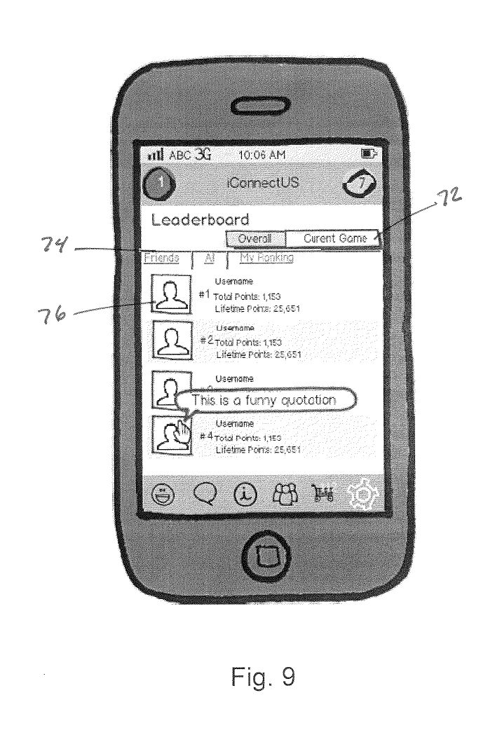

Returning now to FIG. 1, in some embodiments, the post event state may include a leaderboard interaction element 12j. FIG. 9 illustrates one embodiment of a leaderboard interaction element 12j. In the embodiment shown in FIG. 9, the leaderboard interaction element 12j includes a ranking sort 72, a ranking filter 74 and a user list 76. The leaderboard interaction element 12j provides the users with information about the number of points or credits they obtained along with the points or credits obtained by others. The user may use the ranking sort interface 72 to change the user list to include various different sets or subsets. For example, as shown in FIG. 9, the user may select between overall ranking or current game ranking Rankings may also be tied to a particular season of a team or the playoffs or any other set or subset of live events.

In a preferred embodiment, the user may also be able to filter the leaderboard user list 76. In the embodiment shown in FIG. 9, the user can use the filter interface 74 to filter the results to friends, all or just his/her ranking In other embodiments, other filters are possible including filters based on a group discerned from a social media outlet. For example, the user list 76 may be filtered to friends that are from Facebook or another particular social media outlet.

In a preferred embodiment, the leaderboard interaction element 12j may display both points from the last live event and total lifetime points. In other embodiments, other point totals may be displayed. In a preferred embodiment, a user may sort the user list 76 based on any of the point total categories.

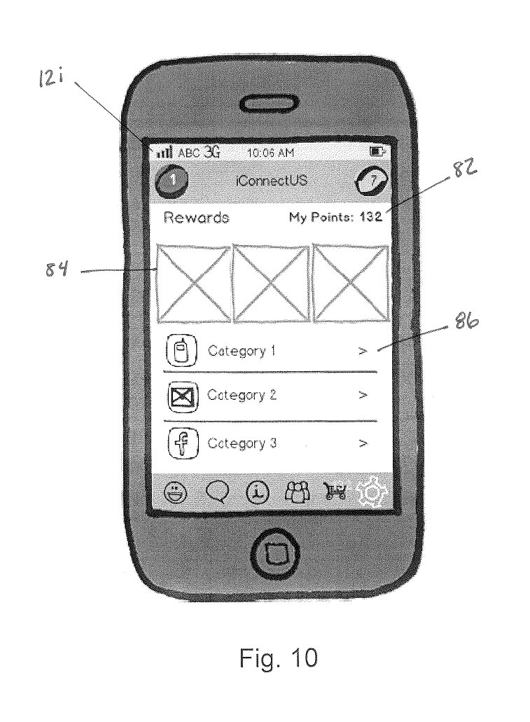

Referring back to FIG. 1, the post event state of the application may include a rewards interaction element 12i. FIG. 10 illustrates an expanded view one embodiment of a rewards interaction element 12i. In the embodiment shown in FIG. 10, the rewards interaction element 12i includes the user rewards point total 82, a featured rewards interface 84, and reward listing 86. The featured rewards interface 84 may include a plurality of featured rewards. The rewards in the featured rewards interface 84 may be sponsored by an advertiser or may be placed their based on popularity.

In the embodiment shown in FIG. 10, a reward listing interface is also provided. The rewards listing may be a scrollable interface that allows the user to scroll through the possible rewards. In a preferred embodiment, the rewards listing 86 may be filtered by point total so that only rewards the user may redeem or come close to redeeming are shown.

In the embodiment shown in FIG. 10, the rewards interface is based on category. Selecting on the category displays a detailed scrollable list of rewards in that category. As one skilled in the art will appreciate, the rewards and their details may be provided through the rewards listing 86 in any hierarchy without departing from the scope of the present patent document.

Once a user selects down to a listing of rewards in the rewards list 86, the necessary points or credits needed to redeem may be provided. In a preferred embodiment, the user may be able to supplement any points or credit shortage with money. To this end, the listing may pre-calculate the remaining monetary value the user will have to pay given that all the user's points are redeemed for the item.

If the user selects on an individual item, a detailed description of the item may be provided along with an interface to allow the user to redeem his/her points for the item. Once the user confirms a reward, a splash screen may be provided instructing the user how to obtain the reward. In a preferred embodiment, the user may be instructed to pick up the reward at the venue of the live event such as in a concession area or merchandise area.

In order to redeem the reward at a local pickup, the user may have to show the redemption screen to the vendor. To this end the redemption screen may contain a bar code or other type of scanable image that will ensure only a single redemption happens. In other embodiments, the reward may be mailed to the user.

Additional points may be awarded for redeeming an award. In addition, the user may post the reward redemption to any social media outlet. Posting the reward redemption to a social media outlet may be rewarded with additional points or credits.

Other aspects of the embodiments in accordance with the present patent document are disclosed in U.S. patent application Ser. No. 13/891,108 titled “Systems, Methods and Machine-Readable Media For Providing and Managing an Interface Between Fans And Celebrities Within a Social Network Environment,” (hereinafter '108 application). The '108 application is hereby incorporated by reference in its entirety.

Although the embodiments have been described with reference to preferred configurations and specific examples, it will readily be appreciated by those skilled in the art that many modifications and adaptations of the embodiments described herein are possible without departure from the spirit and scope of the embodiments as claimed hereinafter. Thus, it is to be clearly understood that this description is made only by way of example and not as a limitation on the scope of the embodiments as claimed below.

What is claimed is:

1. A computer-implemented method of providing an interactive experience to a attendee at a live event, the method comprising:
displaying, via a display on a mobile device, a plurality of interaction elements, wherein a first subset of the interaction elements is designed for use prior to a live event, a second subset of the interaction elements is designed for use during the live event and a third subset of the interaction elements is designed for use after the live event;
receiving, via a processor, a selection of at least one the of the interaction elements; and
processing, via the processor, the selection of at least one of the interaction elements.

2. The computer implemented method of claim 1, further comprising the step of awarding credits or points to an attendee based on a level of participation with the interaction elements.

3. The computer implemented method of claim 1, further comprising uploading media content related to the live event to a social media outlet.

4. The computer implemented method of claim 3, wherein the social media outlet is Facebook®.

5. The computer implemented method of claim 1, wherein one of the interaction elements of the first subset is designed to allow the attendee to submit a question to a participant of the live event.

6. The computer implemented method of claim 5, wherein the question is submitted in video form.

7. The computer implemented method of claim 1, wherein one of the interaction elements of the second subset is designed to allow the user to rate the attractiveness of other attendees at the live event.

8. The computer implemented method of claim 2, wherein additional points or credits are awarded to the attendee for uploading content or information about the live event to a social media outlet.

9. The computer implemented method of claim 1, wherein one of the interaction elements of the third subset is designed to allow the user to redeem points or credits for rewards.

10. The computer implemented method of claim 9, wherein the rewards are selected from the group consisting of coupons, merchandise, concessions or memorabilia.

11. A non-transitory computer-readable medium having computer-readable instructions stored thereon, wherein the computer-readable instructions causes the machine to perform the functions comprising:
providing a first application state, designed to interact with an attendee prior to the live event;
providing a second application state, designed to interact with an attendee during the live event; and
providing a third application state, designed to interact with an attendee after the live event.

12. The non-transitory computer-readable medium of claim 1, the computer readable instruction further causing the machine to perform the function of administering a point or credit allocation system.

13. The non-transitory computer-readable medium of claim 12, wherein the point or credit allocation system allocates points or credits based on the attendees level of interaction with the computer readable instructions.

14. The non-transitory computer-readable medium of claim 13, wherein the points or credits are redeemed for a prize selected from the group consisting of coupons, merchandise and memorabilia.

15. The non-transitory computer-readable medium of claim 13, wherein the credits are redeemed by wagering them against other attendees at the live event.

16. The non-transitory computer-readable medium of claim 11, wherein the computer readable instructions are embodied in a software application executed by the processor of a mobile phone.
